(19) United States
(12) Patent Application Publication
(10) Pub. No.: US 2011/0217938 A1
(43) Pub. Date: Sep. 8, 2011

(54) Wireless Transceiver Device and Control Method

(76) Inventors: Ching-Hwa Yu, Tainan City (TW); Jia-Ching Lee, Hsinchu County (TW)

(21) Appl. No.: 13/023,544

(22) Filed: Feb. 9, 2011

(30) Foreign Application Priority Data
Mar. 5, 2010 (TW) 099106458

(51) Int. Cl. H04W 88/02

(52) U.S. Cl. 455/73

(57) ABSTRACT

A wireless transceiver device used in an electronic device for preventing wireless signal interference includes a plurality of wireless modules for processing wireless signals of a plurality of wireless communication systems, and a control module for adjusting receiving sensitivities or output powers of the plurality of wireless modules, to prevent signals outputted from a wireless module of the plurality of wireless modules from affecting operations of other wireless modules.

### BACKGROUND OF THE INVENTION

1. Field of the Invention

The present invention relates to a wireless transceiver device and a control method, and more particularly, to a wireless transceiver device and control method suitable for an electronic device including a plurality of wireless modules.

2. Description of the Prior Art

As wireless communication techniques advance, the prior art has developed various wireless communication systems, such as mobile communication systems (GSM, 3G, and LTE), wireless local area networks (Wi-Fi, and WiMax), wireless personal area networks (Bluetooth, and Zigbee), etc. To prevent interferences among the communication systems, operating frequency bands and communication techniques, such as modulation, encoding, encryption, etc., employed by the communication systems are usually different. However, under the limitation of wireless communication resources, some of the wireless communication systems have to share the same operating frequency band, leading to an interference issue.

Wi-Fi and Bluetooth are wireless communication techniques commonly introduced in computer systems, portable devices, and other information devices. According to protocol specifications of Bluetooth and Wi-Fi, IEEE 802.15.1 and IEEE 802.11, the operating frequency bands thereof are defined around 2.4 GHz (5 GHz employed in IEEE 802.11a) within an industrial scientific medical (ISM) band. ISM band is world-wide reserved for industrial, scientific and medical usages, and can be utilized without permission if some regulations are followed, to prevent affecting other frequency bands. Under such a situation, even though the protocol specifications, modulating methods and encoding methods of Bluetooth and Wi-Fi are different, interference may occur in an information device because of the same operating frequency band.

For example, if a computer system accesses internet via Wi-Fi and communicates with peripherals, such as headphone, wireless keyboard, mouse, etc., via Bluetooth, signal interference may happen, and lower down the data rate of Wi-Fi, or disconnect the peripherals of Bluetooth partly or entirely, resulting in inconvenience. The above example relates to Bluetooth and Wi-Fi, because these two wireless communication techniques are usually applied to an electronic product, such as notebook computer, personal digital assistant (PDA), etc., and the signal interference scenario is commonly seen. However, since the ISM frequency band is free to use without license, other wireless communication systems operated in the same frequency band may suffer the same signal interference issue. Hence, how to improve signal interference becomes one of the targets in the industry.

### SUMMARY OF THE INVENTION

It is therefore an objective of the claimed invention to provide a wireless transceiver device and a control method.

The present invention discloses a wireless transceiver device used in an electronic device for preventing wireless signal interference, which comprises a plurality of wireless modules, for processing wireless signals of a plurality of wireless communication systems, and a control module, for adjusting receiving sensitivities or output powers of the plurality of wireless modules, to prevent signals outputted from one of the plurality of wireless modules from affecting operations of other wireless modules.

The present invention further discloses a control method for preventing wireless signal interference in an electronic device including a plurality of wireless modules for processing wireless signals of a plurality of wireless systems, which comprises adjusting receiving sensitivities or output powers of the plurality of wireless modules, to prevent signals outputted from one of the plurality of wireless modules from affecting operations of other wireless modules.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless transceiver device according to an embodiment of the present invention.

FIG. 2 to FIG. 7 are schematic diagrams of signal transmission and reception of the wireless transceiver device shown in FIG. 1.

FIG. 8 is a schematic diagram of a control processing according to an embodiment of the present invention.

### DETAILED DESCRIPTION

To prevent wireless signals within the same (e.g. ISM) or neighboring frequency bands from interfering with each other in an electronic device, the present invention adjusts receiving sensitivities or output powers of corresponding wireless modules, to ensure that wireless signals can be successfully received. In general, there are a lot of wireless communication systems using the same or neighboring frequency bands. To clearly illustrate the concept of the present invention, the following embodiment introduces the scenario of two wireless modules in an electronic device. However, the present invention can be applied to any electronic device including more than two wireless modules operated in the same or neighboring frequency bands.

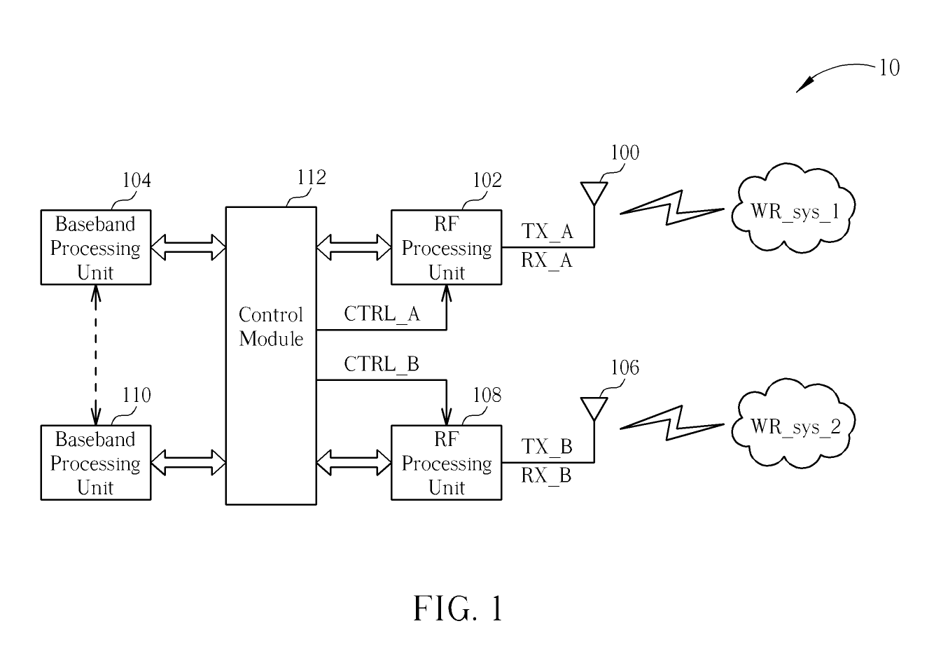

First, please refer to FIG. 1. FIG. 1 is a schematic diagram of a wireless transceiver device 10 according to an embodiment of the present invention. The wireless transceiver device 10 is applied to an information or electronic device, such as a computer system, portable mobile communication system, etc., for processing wireless signals of wireless communication systems WR_sys_1 and WR_sys_2. The wireless communication systems WR_sys_1 and WR_sys_2 are two different communication systems operated in the same or neighboring frequency bands, such as Wi-Fi and Bluetooth. As shown in FIG. 1, the wireless transceiver device 10 comprises antennas 100 and 106, radio-frequency (RF) processing units 102 and 108, baseband processing units 104 and 110, and a control module 112. The antenna 100, the RF processing unit 102, and the baseband processing unit 104 are utilized for processing the wireless signals of the wireless communication system WR_sys_1, to output a signal TX_A to the wireless communication system WR_sys_1 or receive a signal RX_A from the wireless communication system WR_sys_1. Similarly, the antenna 106, the RF processing unit 108, and the baseband processing unit 110 are utilized for processing the wireless signals of the wireless communication system WR_sys_2 , to output a signal TX_B to the wireless communication system WR_sys_2 or receive a signal RX_B from the wireless communication system WR_sys_2. In short, the wireless transceiver device 10 includes two different wireless modules for processing the wireless signals of the wireless communication systems WR_sys_1 and WR_sys_2, respectively. The control module 112 can be regarded as a coexistent circuit of the two wireless modules, and is utilized for outputting control signals CTRL_A and CTRL_B, to control the receiving sensitivities and the output powers of the RF processing units 102 and 108, in order to prevent the wireless signals outputted from one of the two RF processing units from affecting the receiving operations of the other RF processing unit.

In the present invention, the purpose of the control module 112 is to ensure that the RF processing unit performing reception within the RF processing units 102 and 108 is not affected by the RF processing unit performing transmission. Noticeably, whether an RF processing unit performs reception or transmission is determined by operating situations of the wireless transceiver device 10. That is, when the RF processing units 102 and 108 output the signals TX_A and TX B to the wireless communication systems WR_sys_1 and WR_sys_2 at the same time, both of the RF processing units 102 and 108 are transmitters. When the RF processing unit 102 outputs the signal TX_A to the wireless communication system WR_sys_1 and the RF processing unit 108 receives the signal RX_B from the wireless communication system WR_sys_2, the RF processing unit 102 is a transmitter and the RF processing unit 108 is a receiver. Other situations can be derived accordingly.

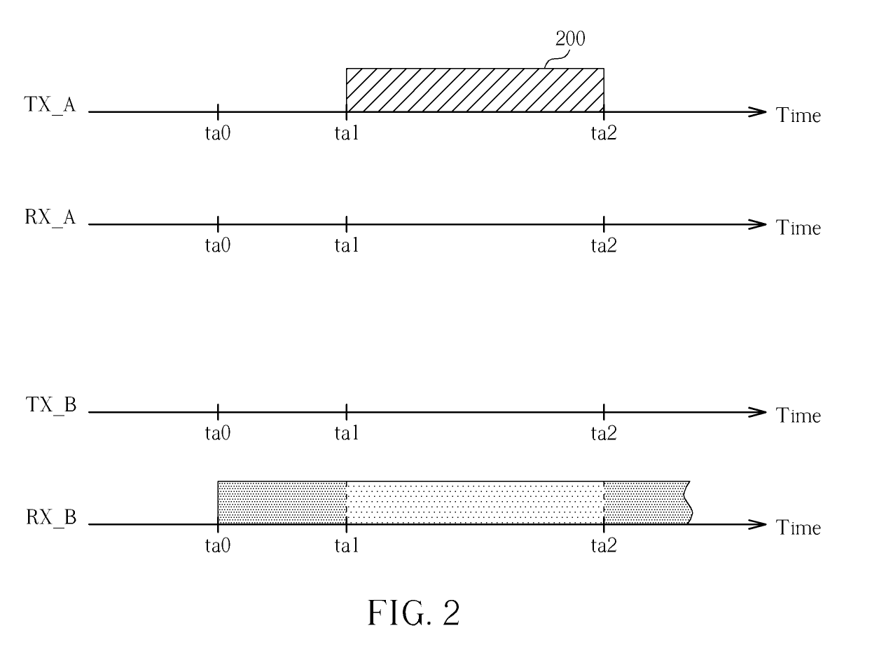

To illustrate the concept of the present invention in detail, please refer to FIG. 2 to FIG. 7. FIG. 2 to FIG. 7 respectively illustrate the transmitting and receiving signals TX_A, RX_A, TX_B, and RX_B of the wireless transceiver device 10 corresponding to the wireless communication systems WR_sys_1 and WR_sys_2 in different situations. In FIG. 2, the RF processing unit 108 operates in the listening mode or idle mode from a time point ta0, to wait or monitor the wireless signals outputted from the wireless communication system WR_sys_2. At a time point ta1, the RF processing unit 102 starts outputting a packet 200, and finishes outputting the packet 200 at a time point ta2. In such a situation, the control module 112 reduces the receiving sensitivity of the RF processing unit 108 between the time point ta1 and the time point ta2 via the control signal CTRL_B, and recovers the original setting at the time point ta2 (FIG. 2 represents the differences of the receiving sensitivities with different dot densities). In other words, during the period ta1-ta2 that the RF processing unit 102 outputs the packet 200, the RF processing unit 108 listens to the wireless signals outputted from the wireless communication system WR_sys_2 with a lower receiving sensitivity, so as to prevent the wireless signals outputted from the RF processing unit 102 from affecting the operations of the RF processing unit 108.

Therefore, in FIG. 2, when a wireless module in the wireless transceiver device 10 outputs wireless signals, the wireless module in the listening mode decreases the receiving sensitivity, to avoid being interfered. There are a variety of methods for decreasing the receiving sensitivity, and one is to reduce a gain of a low-noise amplifier of the RF processing unit 108, to prevent the RF processing unit 108 from processing the packet 200 outputted from the RF processing unit 102 as a correct packet. In addition, if the RF processing unit 108 detects the wireless signals outputted from the wireless communication system WR_sys_2 in the listening mode, the timing of recovering the receiving sensitivity of the RF processing unit 108 can be adjusted based on system configurations.

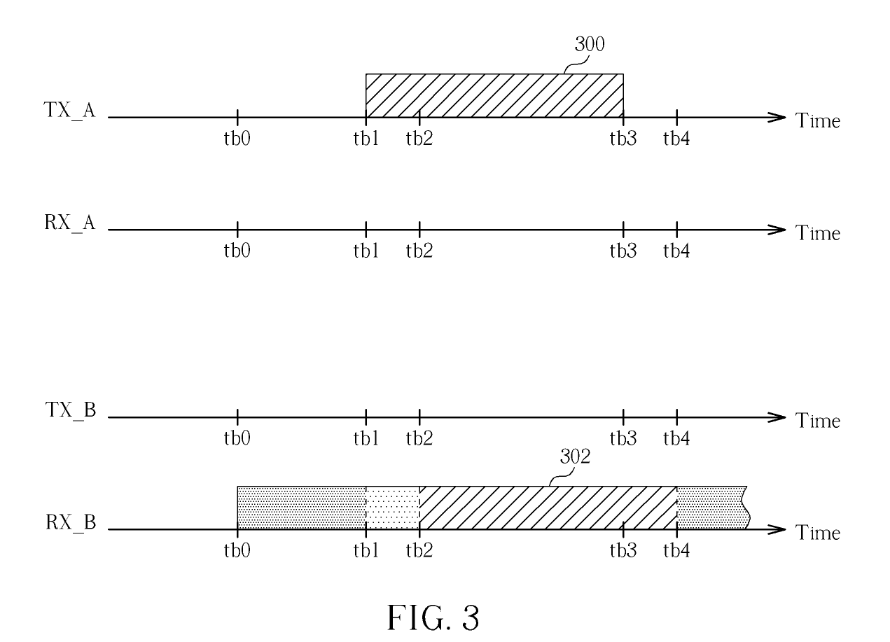

For example, in FIG. 3, the RF processing unit 108 operates in the listening mode from a time point tb0, and the RF processing unit 102 starts outputting a packet 300 at a time point tb1. Therefore, the control module 112 controls the RF processing unit 108 to decrease the receiving sensitivity at the time point tb1 via the control signal CTRL_B. Then, at a time point tb2, the RF processing unit 108 detects a packet 302 outputted from the wireless communication system WR_sys_2 and starts receiving the packet 302. When the RF processing unit 108 finishes receiving the packet 302 at a time point tb4, the control module 112 recovers the receiving sensitivity of the RF processing unit 108 to the original setting via the control signal CTRL_B. In other words, when the RF processing unit 102 finishes outputting the packet 300 at a time point tb3, the control module 112 does not immediately adjust the receiving sensitivity of the RF processing unit 108, but adjusts the receiving sensitivity after the RF processing unit 108 finishes receiving the packet 302. Certainly, if the system can dynamically adjust the receiving sensitivity when receiving packets, the control module 112 could immediately recover the receiving sensitivity of the RF processing unit 108 to the original setting at the time point tb3.

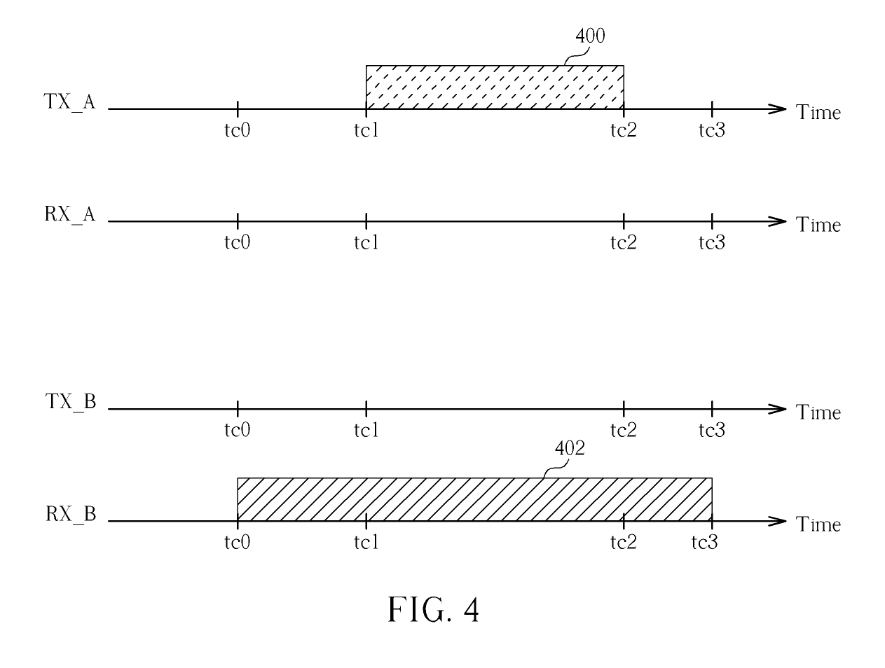

In FIG. 4, the RF processing unit 108 receives a packet 402 outputted from the wireless communication system WR_sys_2 between a time point tc0 and a time point tc3. During this period, the RF processing unit 102 outputs a packet 400 between a time point tc1 and a time point tc2, and the control module 112 decreases the output power of the RF processing unit 102 between the time point tc1 and the time point tc2 via the control signal CTRL_A (the dotted lines shown in FIG. 4 represent the lower output power of the RF processing unit 102) and recovers the output power to the original setting at the time point tc2. In other words, during the period tc1-tc3 that the RF processing unit 108 receives the packet 402, if the RF processing unit 102 requires outputting the packet 400, the control module 112 controls the RF processing unit 102 to output the packet 400 with lower output power. As a result, the wireless signals outputted from the RF processing unit 102 does not affect the receiving operations of the RF processing unit 108.

Therefore, as shown in FIG. 4, when a wireless module of the wireless transceiver device 10 receives wireless signals, another wireless module, which starts outputting wireless signals, decreases the output power, to avoid affecting the operations of the wireless module which receives wireless signals. There are a variety of methods for decreasing the output power, and one is to reduce a gain of a power amplifier of the RF processing unit 102, which is well known by those skilled in the art.

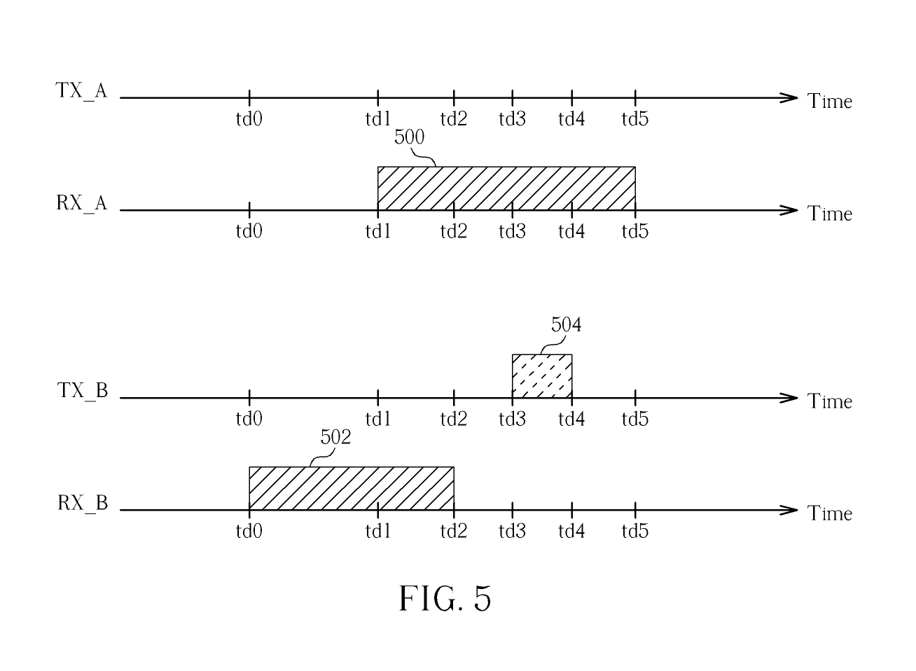

Please note that, the present invention intends to improve the situation that the receiving and outputting operations are simultaneously performed by different wireless modules in a wireless transceiver device. If all the wireless modules are under the receiving state, interference between wireless modules does not happen, such that receiving sensitivities or output powers are unnecessary to be adjusted. For example, in FIG. 5, the RF processing unit 108 receives a packet 502 outputted from the wireless communication system WR_sys_2 between a time point td0 and a time point td2, and the RF processing unit 102 receives a packet 500 outputted from the wireless communication system WR_sys_1 between the time point td1 and a time point td5. When finishing receiving the packet 502, the RF processing unit 108 intends to return a packet 504 to the wireless communication system WR_sys_2 between a time point td3 and a time point td4, to reply a receiving state of the packet 502. Since the receiving and outputting operations are simultaneously performed during the period td3-td4, the control module 112 decreases the output power of the RF processing unit 108 via the control signal CTRL_B according to the present invention, to prevent the packet 502 outputted from the RF processing unit 108 from affecting the operations of the RF processing unit 102.

In addition, FIG. 2 to FIG. 5 are to illustrate the concept of the present invention, to illustrate that when an electronic device includes more than two wireless modules operated in the same or neighboring frequency bands, the present invention can ensure that wireless signals can be successfully received via adjusting receiving sensitivities or output powers. Moreover, those skilled in the art can make modifications according to the present invention. For example, if a wireless module (as a transmitter) in the wireless transceiver device 10 transmits wireless signals and another wireless module (as a receiver) starts receiving wireless signals, the operations of the transmitter can be adjusted according to a priority degree of the wireless signals to be received. In general, for maintaining normal wireless connections, the wireless communication systems WR_sys_1 and WR_sys_2 exchange important system signals, such as control signaling, radio bearers, etc., with the wireless transceiver device 10. In such a situation, the present invention can further adjust the operations of the transmitter according to the priority degree of the wireless signals to be received.

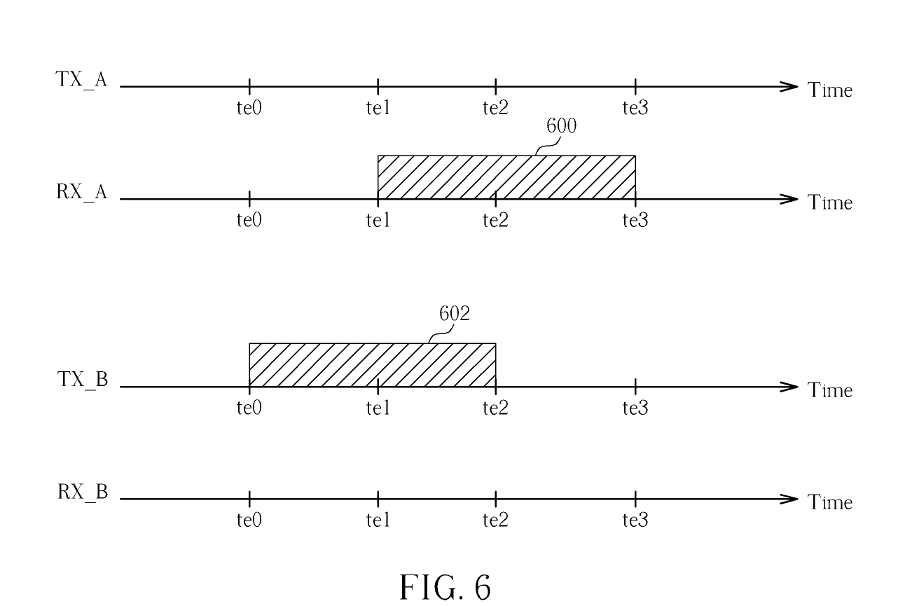

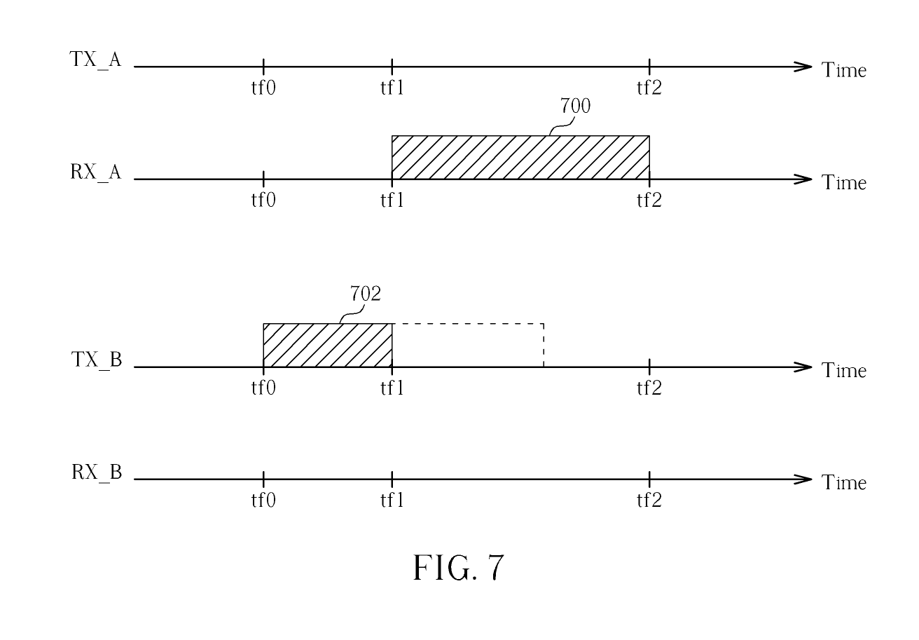

As shown in FIG. 6, the RF processing unit 108 outputs a packet 602 to the wireless communication system WR_sys_2 between a time point te0 and a time point te2, and the RF processing unit 102 receives a packet 600 outputted from the wireless communication system WR_sys_1 between a time point te1 and a time point te3. If the packet 600 has a lower priority in comparison with the packet 602, the control module 112 can maintain the transmission operations of the RF processing unit 108. In addition, as shown in FIG. 7, the RF processing unit 108 outputs a packet 702 to the wireless communication system WR_sys_2 between a time point tf0 and a the time point tf2, and the RF processing unit 102 receives a packet 700 outputted from the wireless communication system WR_sys_1 between a time point tf1 and a time point tf3. If the packet 700 has a higher priority in comparison with the packet 702, the control module 112 can stop the transmission operations of the RF processing unit 108 or set the output power to be 0, to prevent the signals outputted by the RF processing unit 108 from affecting the reception of the packet 700. As a result, according to the priority of the receiving packets, the present invention can properly adjust the operations of the transmitter, and ensure that the system control signals can be successfully received, to maintain wireless connections.

Therefore, as can be seen, when an electronic device includes more than two wireless modules operated in the same or neighboring frequency bands, the present invention can ensure that wireless signals can be successfully received via adjusting receiving sensitivities or output powers. Please note that, the examples mentioned in the above illustrate the electronic device with two wireless modules. In fact, the present invention is suitable for every electronic device equipped with more than two wireless modules operated in the same or neighboring frequency bands, and expanding the except of the present invent to an architecture with a plurality of wireless modules is well known for those skilled in the art. Moreover, in FIG. 1, the connections between the elements represent signal flows, and signal formats or contents are not restricted in any rule. For example, when the RF processing unit 102 outputs wireless signals to the wireless communication system WR_sys_1, the baseband processing unit 104 can output an indicating signal to the baseband processing unit 110, or vice versa. In addition, functions executed by the elements depend on system requirements; for example, adjustments of the receiving sensitivities or output powers of the RF processing units 102 and 108 can be dominated by the control module 112. That is, the control module 112 properly adjusts the receiving sensitivities or output powers according to the operations of the RF processing units 102 and 108 or the priority degree of the signals. Furthermore, the control module 112 represents a functional block to implement the concept of the present invention, and can be implemented by firmware or hardware, or integrated into the baseband processing units 104 and 110 or the RF processing units 102 and 108.

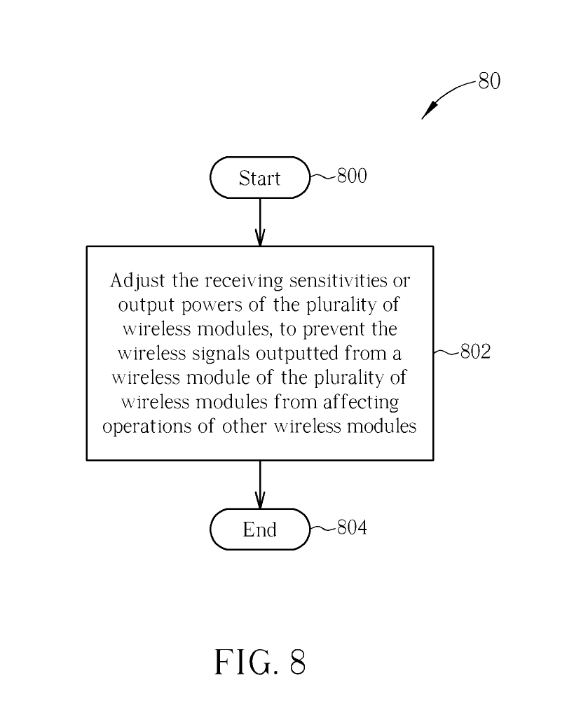

The operations of the control module 112 mentioned in the above can be further concluded or derived into a control processing 80, as shown in FIG. 8, for preventing wireless interference in an electronic device including a plurality of wireless modules. The control process 80 includes the following steps:

Step 800: Start.

Step 802: Adjust the receiving sensitivities or output powers of the plurality of wireless modules, to prevent the wireless signals outputted from a wireless module of the plurality of wireless modules from affecting operations of other wireless modules.

Step 804: End.

Detailed illustrations or modifications of the control process 80 can be referred to the above, and thus, are not further narrated.

In the prior art, since Bluetooth and Wi-Fi operates in the same frequency band, when the related wireless modules operate in an information device, a mutual interfering issue may happen. In comparison, the present invention can adjust the receiving sensitivities or output powers of the Bluetooth or Wi-Fi module, to prevent the mutual interfering issue and maintain normal wireless connections.

To sum up, as to an electronic device including more than two wireless modules operated in the same or neighboring frequency bands, the present invention properly adjusts receiving sensitivities or output powers according to the operations of the wireless modules, signal priorities, etc., to ensure that wireless signals can be successfully received.

Those skilled in the art will readily observe that numerous modifications and alterations of the device and method may be made while retaining the teachings of the invention.

What is claimed is:

1. A wireless transceiver device used in an electronic device for preventing wireless signal interference, comprising:
a plurality of wireless modules, for processing wireless signals of a plurality of wireless communication systems; and
a control module, for adjusting receiving sensitivities or output powers of the plurality of wireless modules, to prevent signals outputted from one of the plurality of wireless modules from affecting operations of other wireless modules.

2. The wireless transceiver device of claim 1, wherein the control module is utilized for reducing receiving sensitivities of a plurality of second wireless modules listening wireless signals within the plurality of wireless modules when a first wireless module of the plurality of wireless modules starts outputting wireless signals.

3. The wireless transceiver device of claim 2, wherein the control module is further utilized for recovering the receiving sensitivities of the plurality of second wireless modules when the first wireless module finishes outputting wireless signals.

4. The wireless transceiver device of claim 2, wherein after the first wireless module starts outputting the wireless signals and when a second wireless module of the plurality of second wireless modules receives wireless signals, the control module is further utilized for recovering a receiving sensitivity of the second wireless module after the second wireless module finishes receiving the wireless signals.

5. The wireless transceiver device of claim 1, wherein the control module is utilized for reducing output powers of a plurality of second wireless modules starting outputting wireless signals within the plurality of wireless modules when a first wireless module of the plurality of wireless modules receives wireless signals.

6. The wireless transceiver device of claim 5, wherein the control module is further utilized for recovering the output powers of the plurality of second wireless modules when the plurality of second wireless modules finish outputting the wireless signals.

7. The wireless transceiver device of claim 1, wherein the control module is utilized for reducing output powers of a plurality of second wireless modules starting outputting wireless signals within the plurality of wireless modules when a first wireless module of the plurality of wireless modules receives wireless signals.

8. The wireless transceiver device of claim 7, wherein the control module is further utilized for recovering the output powers of the plurality of second wireless modules when the plurality of second wireless modules finish outputting the wireless signals.

9. The wireless transceiver device of claim 1, wherein the control module is further utilized for controlling output powers of a plurality of second wireless modules having started outputting wireless signals within the plurality of wireless modules according to a priority degree of wireless signals received by a first wireless module of the plurality of wireless modules.

10. The wireless transceiver device of claim 9, wherein the control module is utilized for maintaining the output powers of the plurality of second wireless modules when the priority degree of the wireless signals received by the first wireless module is lower than a predetermined level.

11. The wireless transceiver device of claim 9, wherein the control module is utilized for reducing the output powers of the plurality of second wireless modules when the priority degree of the wireless signals received by the first wireless module is greater than a predetermined level.

12. The wireless transceiver device of claim 9, wherein the control module is utilized for stopping the plurality of second wireless modules from outputting the wireless signals when the priority degree of the wireless signals received by the first wireless module is greater than a predetermined level.

13. The wireless transceiver device of claim 1, wherein each of the plurality of wireless modules comprises:
at least an antenna;
a radio-frequency (RF) processing unit, for transmitting and receiving wireless signals via the at least antenna; and
a baseband processing unit, for processing wireless signals received by the RF processing unit, or outputting signals to the RF processing unit.

14. The wireless transceiver device of claim 13, wherein the control module is set between the RF processing unit and the baseband processing unit of each of the wireless modules.

15. The wireless transceiver device of claim 13, wherein the control module is set in the RF processing unit of each of the wireless modules.

16. A control method for preventing wireless signal interference in an electronic device comprising a plurality of wireless modules for processing wireless signals of a plurality of wireless systems, comprising:
adjusting receiving sensitivities or output powers of the plurality of wireless modules, to prevent signals outputted from one of the plurality of wireless modules from affecting operations of other wireless modules.

17. The control method of claim 16, wherein the step of adjusting the receiving sensitivities or the output powers of the plurality of wireless modules comprises reducing receiving sensitivities of a plurality of second wireless modules listening wireless signals within the plurality of wireless modules when a first wireless module of the plurality of wireless modules starts outputting wireless signals.

18. The control method of claim 17, comprising recovering the receiving sensitivities of the plurality of second wireless modules when the first wireless module finishing outputting wireless signals.

19. The control method of claim 17, further comprising after the first wireless module starts outputting the wireless signals and when a second wireless module of the plurality of second wireless modules receives wireless signals, recovering a receiving sensitivity of the second wireless module after the second wireless module finishes receiving the wireless signals.

20. The control method of claim 16, wherein the step of adjusting the receiving sensitivities or the output powers of the plurality of wireless modules comprises reducing output powers of a plurality of second wireless modules starting outputting wireless signals within the plurality of wireless modules when a first wireless module of the plurality of wireless modules receives wireless signals.

21. The control method of claim 20, further comprising recovering the output powers of the plurality of second wireless modules when the plurality of second wireless modules finishes outputting the wireless signals.

22. The control method of claim 16, wherein the step of adjusting the receiving sensitivities or the output powers of the plurality of wireless modules comprises reducing output powers of a plurality of second wireless modules having started outputting wireless signals within the plurality of wireless modules when a first wireless module of the plurality of wireless modules receives wireless signals.

23. The control method of claim 22, further comprising recovering the output powers of the plurality of second wireless modules when the plurality of second wireless modules finishes outputting the wireless signals.

24. The control method of claim 16, wherein the step of adjusting the receiving sensitivities or the output powers of the plurality of wireless modules comprises controlling output powers of a plurality of second wireless modules having started outputting wireless signals within the plurality of wireless modules according to a priority degree of wireless signals received by a first wireless module of the plurality of wireless modules.

25. The control method of claim 24, further comprising maintaining the output powers of the plurality of second wireless modules when the priority degree of the wireless signals received by the first wireless module is lower than a predetermined level.

26. The control method of claim 24, further comprising reducing the output powers of the plurality of second wireless modules when the priority degree of the wireless signals received by the first wireless module being greater than a predetermined level.

27. The control method of claim 24, further comprising stopping the plurality of second wireless modules from outputting the wireless signals when the priority degree of the wireless signals received by the first wireless module being greater than a predetermined level.
